(19) United States
(12) Patent Application Publication
(10) Pub. No.: US 2016/0132908 A1
(43) Pub. Date: May 12, 2016

(54) Methods And Apparatus For Transaction Prediction

(71) Applicant: Mastercard International Incorporated, Purchase, NY (US)

(72) Inventors: Cristobel Kay von Walstrom, Greenwich, CT (US); Bruce William Mac Nair, Stamford, CT (US); Annabel Truscott, Ossining, NY (US); Ashwath Murali, New York, NY (US); Gene K. Corcoran, Larchmont, NY (US)

(21) Appl. No.: 14/538,320

(22) Filed: Nov. 11, 2014

(51) Int. Cl. G06Q 30/02; G06Q 10/06

(52) U.S. Cl. CPC G06Q 30/0202; G06Q 30/0255; G06Q 10/06315

(57) ABSTRACT

A system, method, and computer-readable storage medium configured to enable transaction-related user behavior modeling of individuals based on their payment card purchases. The user behavior modeling can provide predictions on next transaction information. One or more recommendations can be determined based on the next transaction information.

### BACKGROUND

1. Field of the Disclosure

Aspects of the disclosure relate in general to data mining of financial transactions. Aspects include an apparatus, system, method and computer-readable storage medium to enable purchase prediction of individuals based on their payment card purchases.

2. Description of the Related Art

The use of payment cards, such as credit or debit cards, is ubiquitous in commerce. Typically, a payment card is electronically linked via a payment network to an account or accounts belonging to a user (e.g., a cardholder). These accounts are generally deposit accounts, loan or credit accounts at an issuer financial institution. During a purchase transaction, the user (e.g., cardholder) can present the payment card in lieu of cash or other forms of payment.

Payment networks process billions of purchase transactions by cardholders. The data from the purchase transactions can be used to analyze user behavior. Typically, the transaction data can be used after it is summarized up to user level. Unfortunately, the current transaction rolled-up processes are pre-knowledge based and does not result in transaction level models. There is a need for more sophisticated method and apparatus to use the existing transaction data to model user behavior and therefore predict next transaction information of users.

### SUMMARY

Embodiments include a system, apparatus, device, method and computer-readable medium configured to enable user behavior modeling of individuals based on their payment card purchases.

In a purchase prediction embodiment, transaction data related to one or more users regarding a financial transaction is received, for example, from one or more databases. The transaction data includes one or more transaction attributes. A processor models user behavior (e.g., calculate spending patterns) associated with one or more users based on the received transaction data. The user behavior model is saved to a non-transitory computer-readable storage medium. The processor determines next transaction information associated with the one or more users based on the user behavior associated with the one or more users. The processor further determines one or more recommendations to the one or more users based on the next transaction information.

### BRIEF DESCRIPTION OF THE DRAWINGS

FIG. 1 illustrates an embodiment of a system configured to enable user behavior modeling of individuals based on their payment card purchases.

FIG. 2 depicts a diagram of a purchase prediction apparatus configured to enable user behavior modeling of individuals based on their payment card purchases.

### DETAILED DESCRIPTION

One aspect of the disclosure includes the realization that a purchase behavior is a powerful source of information that complements demographics and self-reported preferences to create a complete profile of an individual's lifestyle.

Another aspect of the disclosure includes the understanding that analyzing cardholder spending provides a source of predictive information that may be used for next transaction prediction. For example, frequent purchase on a certain merchant category (e.g., milk) may indicate propensity for purchase of another related merchant category (e.g., cheese). Similarly, frequent purchase on certain time and/or location may be indicators for cardholder spending habit and lifestyle. For example, frequent purchases at health-food stores may be indicators that the cardholder is likely to purchase other health enhancement product at nutrition supplement stores. These and other similar cardholder purchases and expenditures may contain information for the development of a cardholder transaction user behavior model.

Yet another aspect of the disclosure is the realization that a user behavior model may be used to predict next transaction information, and therefore determine one or more recommendations based on the predicted next transaction information. As an example, the one or more recommendations can be used to provide (e.g., identify, generate) one or more offers for one or more users (e.g., cardholders). The metrics for next transaction information prediction include, but are not limited to: time, distance, merchant category, or any other types of metrics known in the art. For example, the next transaction information prediction can include that a specific user is likely to purchase a certain category of merchant within a certain period of time and/or within certain distance since a previous purchase. As a specific example, the next transaction information prediction can include predicting a user to purchase grocery within 30 minutes and/or within 5 miles after a gas purchase at a particular gas station. As another specific example, the next transaction information prediction can include predicting a user is likely to go to a nearby movie theater after dining in a restaurant on Saturday. As another example, the next transaction information can comprise amount of time elapsed before a certain percentage (e.g., 25%, 50%, 75%, etc.) of a group of users (e.g., a plurality of users located within a predefined area, a plurality of users within a predefined distance from a certain merchant location) makes a next transaction. As another example, the next transaction information can comprise average time between two sequential transactions for a group of users. As another example, the next transaction information can comprise cumulative distance when a certain percentage (e.g., 25%, 50%, 75%, etc.) of a group of users makes a next transaction. As yet another example, the next transaction information can comprise industry code of next transactions and its associated percentage (e.g., the highest percentage, the second highest percentage, and the third highest percentage) for a group of users. As yet another example, the next transaction information can comprise industry code of next transactions for a group of users in terms of occurring frequency e.g., most frequently occurring, second most frequently occurring, third frequently occurring). The next transaction information can be used for inventory planning at merchant stores.

Embodiments of the present disclosure include a system, method, and computer-readable storage medium configured to enable user behavior modeling of individuals based on their payment card purchases. For the purposes of this disclosure, a payment card includes, but is not limited to: credit cards, debit cards, prepaid cards, electronic checking, electronic wallet, or mobile device payments.

Embodiments may be used in a variety of potential applications, including providing one or more recommendations such as merchant location recommendations, merchant brand recommendations, merchant store recommendations, merchant category recommendation, merchant channel recommendation (e.g., brick and mortar, online, catalog, etc.). The one or more recommendations can be used for targeted promotions (e.g., offers or advertisement based on the one or more recommendations), fraud detection, identification of potential partners for joint promotions, and the like.

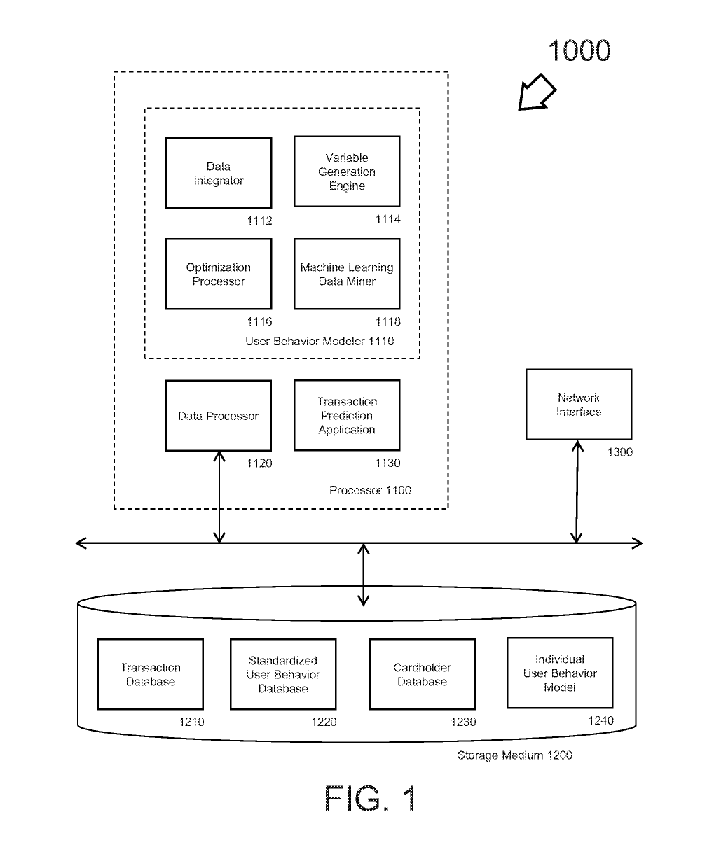

Embodiments will now be disclosed with reference to a block diagram of an exemplary user behavior modeling apparatus server 1000 of FIG. 1 configured to enable transaction-related user behavior modeling of individuals based on their payment card purchases, constructed and operative in accordance with an embodiment of the present disclosure.

User behavior modeling apparatus server 1000 may run a multi-tasking operating system (OS) and include at least one processor or central processing unit (CPU) 1100, a non-transitory computer-readable storage medium 1200, and a network interface 1300. An example operating system may include Advanced Interactive Executive (AIX™) operating system, UNIX operating system, or LINUX operating system, and the like.

Processor 1100 may be any central processing unit, microprocessor, micro-controller, computational device or circuit known in the art. It is understood that processor 1100 may communicate with and temporarily store information in Random Access Memory (RAM) (not shown).

As shown in FIG. 1, processor 1100 is functionally comprised of a user behavior modeler 1110, a transaction prediction application 1130, and a data processor 1120.

User behavior modeler 1110 is a component configured to model user behavior by analyzing financial transactions. As an example, the user behavior modeler 1110 can analyze user behavior such as spending pattern, spending habit, life style, and the like. User behavior can be used for next transaction prediction. User behavior modeler 1110 may further comprise: a data integrator 1112, variable generation engine 1114, optimization processor 1116, and a machine learning data miner 1118.

Data integrator 1112 is an application program interface (API) or any structure that enables the user behavior modeler 1110 to communicate with, or extract data from, a database.

Variable generation engine 1114 is any structure or component capable of generating a user behavior model containing one or more variables from given transaction data.

Optimization processor 1116 is any structure configured to receive variables of the user behavior model defined from an application (e.g., transaction prediction application 1130, discussed in more detail below) and refine the variables.

Machine learning data miner 1118 is a structure that allows users of the user behavior modeler 1110 to enter, test, and adjust different parameters and control the machine learning speed. In some embodiments, machine learning data miner uses decision tree learning, association rule learning, neural networks, inductive logic programming, support vector machines, clustering, Bayesian networks, reinforcement learning, representation learning, similarity and metric learning, spare dictionary learning, and ensemble methods such as random forest, boosting, bagging, and rule ensembles, or a combination thereof to processes one or more transaction attributes of the one or more users using a predefined formula.

In one aspect, the user behavior modeler 1110 can be configured to process one or more transaction attributes of the one or more users using a predefined formula. For example, the predefined formula can comprise additions, subtractions, averages, or any other predetermined mathematical operations. As an example, the one or more transaction attributes can comprise a transaction account, a transaction time, a transaction class, a transaction location, user information, purchase channel, service stock-keeping unit (SKU), transaction amount, and merchant details, and the like.

Transaction prediction application 1130 is an application that performs next transaction prediction by utilizing information stored in databases stored in computer-readable storage medium 1200 and user behavior modeler 1110.

Data processor 1120 enables processor 1100 to interface with storage medium 1200, network interface 1300 or any other component not on the processor 1100. The data processor 1120 enables processor 1100 to locate data on, read data from, and write data to these components.

These structures may be implemented as hardware, firmware, or software encoded on a computer readable medium, such as storage medium 1200. Further details of these components are described with their relation to method embodiments below.

Network interface 1300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 1300 allows user behavior modeling apparatus server 1000 to communicate with vendors, cardholders, and/or issuer financial institutions.

Computer-readable storage medium 1200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage medium 1200 may be remotely located from processor 1100, and be connected to processor 1100 via a network such as a local area network (LAN), a wide area network (WAN), or the Internet.

In addition, as shown in FIG. 1, storage medium 1200 may also contain a transaction database 1210, standardized user behavior database 1220, cardholder database 1230 and an individual user behavior model 1240. Transaction database 1210 is configured to store records of payment card transactions. For example, transaction database can include a transaction account, a transaction time, a transaction class, a transaction location, user information, purchase channel, service stock-keeping unit (SKU), transaction amount, and merchant details. Standardized user behavior database 1220 is configured to store standardized user behavior information; in some embodiments, the standardized user behavior database 1220 may also contain information about user behavior variables and common transaction patterns. Cardholder database 1230 is configured to store cardholder information and transactions information related to specific users (e.g., cardholders). In some embodiments, cardholder database 1230 may be the transaction database 1210 organized by cardholder information. An individual user behavior model 1240 is a user behavior model for a cardholder based on cardholder transactions. In one aspect, user behavior model takes into account of user age, gender, location, spending habit, life style, and the like. In some embodiments, an individual cardholder's transactions may be compared to transactions made by other cardholder transactions.

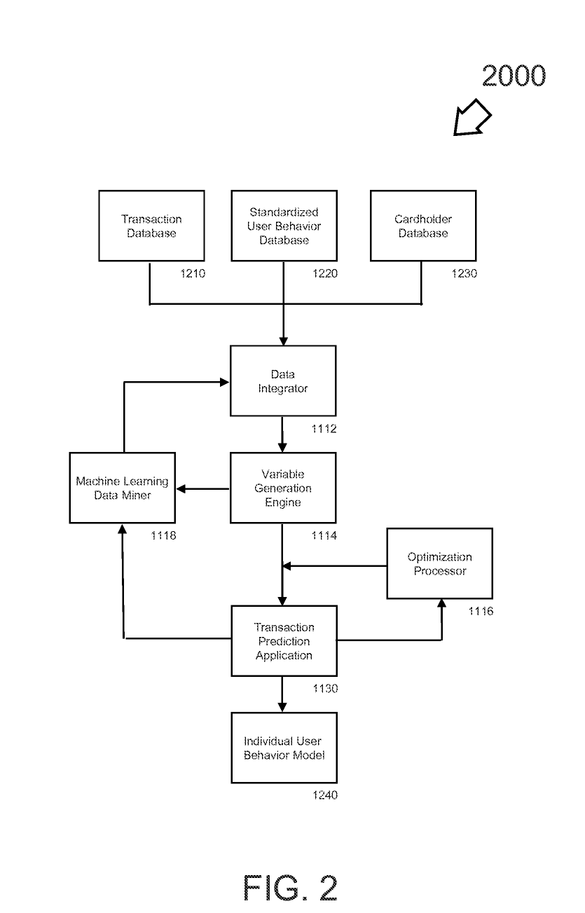

It is understood by those familiar with the art that one or more of these databases 1210-1240 may be combined in a myriad of combinations. The function of these structures may best be understood with respect to the data flow diagram of FIG. 2, as described below.

We now turn our attention to the method or process embodiments of the present disclosure described in the data flow diagram of FIG. 2. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIG. 2 is a data flow diagram of a transaction prediction method 2000 to enable purchase-related user behavior modeling of individuals based on their payment card purchases, constructed and operative in accordance with an embodiment of the present disclosure. The resulting individual user behavior model 1240 may be used to determine metrics associated with a next transaction prediction application 1130. For example, the individual user behavior model 1240 metrics can determine a next transaction made by a particular account number after a transaction at a certain merchant location. In other words, these metrics would show, for a particular merchant location, how quickly a follow-up transaction can be made by a given account, how close to a merchant store the follow-up transaction occurred, what merchant categories are most likely to be in the follow-up transaction, and the like.

The next transaction is a next sequential transaction ordered by transaction in time for a given account following a transaction at a given merchant and/or merchant store. The metrics for a next transaction prediction include, but are not limited to: time, distance, merchant category, or any other types of metrics known in the art. For example, the next transaction prediction can include that a specific user is likely to purchase a certain category of merchant within a certain period of time and/or within certain distance since a previous purchase. As a specific example, the next transaction prediction can include predicting a user to purchase grocery within 30 minutes and/or within 5 miles after a gas purchase at a particular gas station. As another specific example, the next transaction prediction can include predicting a user is likely to go to a nearby movie theater after dining in a restaurant on Saturday. As another example, the next transaction information can comprise amount of time elapsed before a certain percentage (e.g., 25%, 50%, 75%, etc.) of a group of users (e.g., a plurality of users located within a predefined area, a plurality of users within a predefined distance from a certain merchant location) makes a next transaction. As another example, the next transaction information can comprise average time between two sequential transactions for a group of users. As another example, the next transaction information can comprise cumulative distance when a certain percentage (e.g., 25%, 50%, 75%, etc.) of a group of users makes a next transaction. As yet another example, the next transaction information can comprise industry code of next transactions and its associated percentage (e.g., the highest percentage, the second highest percentage, and the third highest percentage) for a group of users. As yet another example, the next transaction information can comprise industry code of next transactions for a group of users in terms of occurring frequency (e.g., most frequently occurring, second most frequently occurring, third frequently occurring). The next transaction information can be used for inventory planning at merchant stores.

One or more recommendations can be determined based on the metrics for the next transaction prediction. As an example, one or more recommendations can comprise recommended merchant store names, recommended merchant store locations (e.g., GPS coordinates, physical addresses), recommended merchant brand, recommended merchant category (e.g., grocery, electronics, gas, etc.), and recommended merchant channel (e.g., brick and mortar, online, catalog, etc.). For example, if the next transaction information indicates that a user is likely to purchase a movie ticket in a follow up purchase, a location can be recommended to the user for purchasing a movie ticket at a lower price. Similarly, a certain website can be recommended to the user for purchasing a movie ticket.

One or more offers can be provided to one or more users (e.g., cardholders) based on the one or more recommendations. For example, an offer (e.g., a coupon) from a movie theater can be provided (e.g., identified and/or generated) based on the one or more recommendations. As another example, an annual pass for a park can be provided to one or more users based on the one or more recommendations.

Method 2000 is a batch method that enables user behavior modeling of individuals based on their payment card purchases.

As shown in FIG. 2, data integrator 1112 receives data from a transaction database 1210, standardized user behavior database 1220, and cardholder database 1230. The data may be filtered by time range, location, merchant category, depending upon data availability or desirability.

The cardholder's individual transaction data may come from a transaction database 1210, a cardholder database, 1230 or both. The cardholder's individual transaction data includes a transaction entry for each financial transaction performed with a payment card. Each transaction entry may include, but is not limited to: transaction account information (e.g., an anonymized customer account identifier), a transaction time, a transaction class, a transaction location, customer information (e.g., customer geography, customer type, and customer demographics), merchant details (name, geographic location, line of business, and firm demographics), purchase channel (on-line versus in-store transaction), product or service stock-keeping unit (SKU), and transaction amount.

A standardized user behavior database 1220 provides external data sources for user behavior evaluation. These data sources may include a sample of cardholders with credit ratings, education background, gender, geographic metrics, income levels, or other variables that contribute to the user behavior analytics.

Data integrator 1112 provides the data to the variable generation engine 1114. Variable generation engine 1114 produces a variable layer with transaction attribute variables to support the user behavior analysis. Examples of such variable include, but are not limited to: merchant categorization, merchant store categories, transaction class (e.g., individual purchase, business purchase), transaction amount, healthy versus unhealthy activities, life stage indicators, transaction measures (e.g., frequency or total spend in any of the categories), or changes in behavior.

Statistical techniques know in the art are used to derive user behavior insights, for example, user spending patterns, based on transaction attribute variables.

For any transaction prediction application 1130 with at least one transaction attribute of interest, Xᵢ(A; t, l) can denote a transaction attribute variable at transaction level belonging to an account A, by transaction time stamp t, and transaction location l. For example, X can be payment amount or any transaction related attribute, and V_{A}(x) can be a summarized variable at the customer level which can be any function of original transaction attribute x for a given individual user behavior model 1240, designated as target T.

Once generated, the transaction attribute of interest, is provided to the transaction prediction application 1130 and the machine learning data miner 1118. The machine learning data miner 1118 receives inputs from both the variable generation engine 1114 and the transaction prediction application 1130 to refine the individual user behavior model 1240. Machine learning data miner 1118 starts with dozens of attributes of the transaction data, and computes the implicit relationships of these attributes and the relationship of the attributes to the transaction prediction application 1130. The machine learning data miner 1118 derives from or transforms these attributes to their most useful form, then selects the variables for the variable generation engine 1114.

Transaction prediction application 1130 also feeds information to optimization processor 1116. The optimization process happens after the variables are created by modeling processes:

$$\{ {X}_{i} ( A ; t , ) \} {}^{Specific and to Maximize relevant V \to T} {V}_{A} ( x , T )$$

Optimization processor 1116 maximizes the correlation of the generated variables V with the target T by searching optimal mapping [symbol] and roll-up function [symbol] :

$$V ( x ) {}^{Model} T .$$

The searching space for the optimal mapping and functions is large, and the optimization processor 1116 may test the searching process with a limited domain. For example, one simplified approach is to fix the function dimension [symbol] = [symbol] , and searching the optimal mapping [symbol] .

In essence, the optimization processor 1116 learns from vast transactional data, explores target relevant data dimensions, and generates optimal user (e.g., cardholder) level variable summarization rules automatically. The optimization processor 1116 is similar to the machine learning data miner 1118, but the difference is that optimization processor 1116 is working on the data that has been aggregated to the account level. The final individual user behavior model 1240 is implemented on each account for actions to be taken upon.

The optimization processor 1116 starts with selected variables (attributes) of each account (customer) and applies the statistical analysis to reduce the list of variables that appear to be related to various user behaviors and purchases based on the customer's transaction data. The optimization may be accomplished by computing the relationship of these variables to the transaction prediction application 1130, and derives from or transforms these variables to their most useful form, applying the analytic phase to a broad universe of cardholders.

The feedback from optimization processor 1116 and machine learning data miner 1118 provides a machine learning approach for transactional prediction.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A transaction prediction method comprising:
receiving transaction data related to one or more users regarding a plurality of financial transactions, the transaction data including one or more transaction attributes;
modeling, via a processor, user behavior associated with the one or more users based on the received transaction data;
determining, via the processor, next transaction information associated with the one or more users based on the user behavior associated with the one or more users; and
determining, via the processor, one or more recommendations to the one or more users based on the next transaction information.

2. The transaction prediction method of claim 1, wherein the one or more transaction attributes include one or more of: a transaction account, a transaction time, a transaction class, a transaction location, user information, purchase channel, service stock-keeping unit, (SKU), transaction amount, and merchant details.

3. The transaction prediction method of claim 1, wherein the next transaction information associated with the one or more users comprises time, distance, and merchant category associated with respective next transaction of the one or more users.

4. The transaction prediction method of claim 1, wherein the modeling user behavior associated with the one or more users based on the received transaction data comprises:
processing one or more transaction attributes of the one or more users using a predefined formula.

5. The transaction prediction method of claim 1, wherein the one or more recommendations are used to provide one or more offers for the one or more users.

6. The transaction prediction method of claim 1, wherein the one or more recommendations comprise recommended merchant store names, recommended merchant store locations, recommended merchant brand, recommended merchant category, and recommended merchant channel.

7. The transaction prediction method of claim 1, wherein the next transaction information is used for inventory planning for one or more merchant stores associated with the one or more users.

8. A transaction prediction apparatus comprising:
a processor, configured to
receive transaction data related, to one or more users regarding a financial transaction, the transaction data including a transaction attribute,
model user behavior associated with the one or more users based on the received transaction data,
determine next transaction information associated with the one or more users based on the user behavior, and
determine one or more recommendations to the one or more users based on the next transaction information; and
a non-transitory computer-readable storage medium, configured to:
store the received transaction data, the user behavior model, and the determined next transaction information associated with the one or more users.

9. The transaction prediction apparatus of claim 8, wherein the one or more transaction attributes include one or more of: a transaction account, a transaction time, a transaction class, a transaction location, user information, purchase channel, service stock-keeping unit (SKU), transaction amount, and merchant details.

10. The transaction prediction apparatus of claim 8, wherein modeling user behavior associated with the one or more users based on the received transaction data comprises:
processing one or more transaction attributes of the one or more users using a predefined formula.

11. The transaction prediction apparatus of claim 8, wherein the next transaction information associated with the one or more users comprises time, distance, and merchant category associated with respective next transaction of the one or more users.

12. The transaction prediction apparatus of claim 8, wherein the one or more recommendations are used to provide one or more offers for the one or more users.

13. The transaction prediction apparatus of claim. 8, wherein the one or more recommendations comprise recommended merchant store names, recommended merchant store locations, recommended merchant brand, recommended merchant category, and recommended merchant channel.

14. The transaction prediction apparatus of claim 8, wherein the next transaction information is used for inventory planning for one or more merchant stores associated with the one or more users.

15. A non-transitory computer readable medium encoded with data and instructions, when executed by a computing device the instructions causing the computing device to:
receive transaction data related to one or more users regarding a plurality of financial transactions, the transaction data including one or more transaction attributes;
model user behavior related to the one or more users based on the received transaction data;
determine next transaction information associated with the one or more users based on the user behavior; and
determine one or more recommendations to the one or more users based on the determined next transaction information.

16. The non-transitory computer readable medium of claim 15, wherein the one or more transaction attribute include one or more of: a transaction account, a transaction time, a transaction class, a transaction location, user information, purchase channel, service stock-keeping unit (SKU), transaction amount, and merchant details.

17. The non-transitory computer readable medium of claim 15, wherein the next transaction information associated with the one or more users comprises time, distance, and merchant category associated with respective next transaction of the one or more users.

18. The non-transitory computer readable medium of claim 15, wherein the one or more recommendations are used to provide one or more offers for the one or more users.

19. The non-transitory computer readable medium of claim 15, wherein the one or more recommendations comprise recommended merchant, store names, recommended merchant store locations, recommended merchant brand, recommended merchant category, and recommended merchant channel.

20. The non-transitory computer readable medium of claim 19, the next transaction information associated with the one or more users is used for inventory planning for one or more merchant stores associated with the one or more users.
